(19) United States
(12) Patent Application Publication
(10) Pub. No.: US 2016/0350318 A1
(43) Pub. Date: Dec. 1, 2016

(54) METHOD, SYSTEM FOR CLASSIFYING COMMENT RECORD AND WEBPAGE MANAGEMENT DEVICE

(71) Applicant: HON HAI PRECISION INDUSTRY CO., LTD., New Taipei (TW)

(72) Inventors: YIN-MIN LIN, New Taipei (TW); HO-I SUN, New Taipei (TW)

(21) Appl. No.: 14/858,621

(22) Filed: Sep. 18, 2015

(30) Foreign Application Priority Data
May 26, 2015 (TW) 104116872

(51) Int. Cl. G06F 17/30; G06F 3/0482; G06F 17/27; G06F 3/0484

(52) U.S. Cl. CPC G06F 17/3089; G06F 17/30713; G06F 3/04842; G06F 3/0482; G06F 17/275

(57) ABSTRACT

A method for classifying comment record includes: detecting a language of a browser used to access to a webpage file when the webpage file is accessed by the browser; acquiring comment records related to webpage content of the webpage file and a language identifier of each one comment record, determining the language of each comment record according to the acquired language identifier of each comment record and the relationships between a number of the languages and a number of language identifiers defined in a relationship table, and selecting the comment records, whose language match with the language of the browser, from all of the acquired comment records; and displaying the selected comment records in the comment display area of the webpage file.

### CROSS-REFERENCE TO RELATED APPLICATIONS

This application claims priority to Taiwanese Patent Application No. 104116872 filed on May 26, 2015, the contents of which are incorporated by reference herein.

### FIELD

The subject matter herein generally relates to internet field, especially relates to a method and a system for classifying comment record and a webpage management device.

### BACKGROUND

Nowadays, with the development of the Internet, an increasing number of people communicate with each other on the Internet. For example, for some popular videos on a video website, many people from different countries can discuss and express their opinions about the videos via a comment area of the video website. However, as people from different countries have different languages, it is difficult for people to achieve effective communication and get value advice from videos.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a block diagram of an embodiment of a running environment of a system for classifying comment records.

FIG. 2 is a diagrammatic view of an embodiment of a relationship table.

FIG. 3 is a diagrammatic view of an embodiment of a webpage file.

FIG. 4 is a block diagram of an embodiment of the system for classifying comment records.

FIG. 5 is a diagrammatic view of an embodiment of a comment display area in FIG. 3.

FIG. 6 is a diagrammatic view of an embodiment of a comment record with a regional mark.

FIG. 7 is a flowchart of an embodiment of a method for classifying comment records.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of example and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

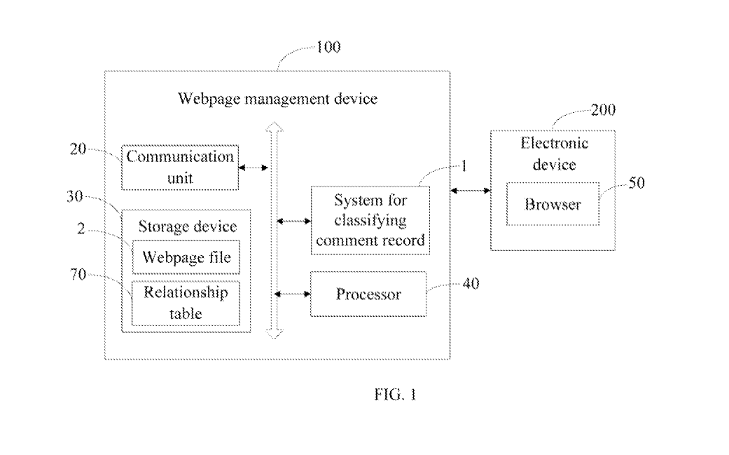

FIG. 1 illustrates a block diagram of an embodiment of a running environment of a system 1 for classifying comment records. The system 1 runs on a webpage management device 100. The webpage management device 100 includes, but is not limited to a communication unit 20, a storage device 30, and at least one processor 40. The webpage management device 100 can communicate with at least one electronic device 200. The storage device 30 of the webpage management device 100 stores a number of webpage files 2. The electronic device 200 includes a browser 50. The electronic device 200 is able to access the webpage files 2 provided by the webpage management device 100 via the browser 50. The browser 50 can be a browser software, for example, an Internet Explorer browser, a Baidu browser, a Google browser, installed on the electronic device 200. The storage device 30 stores a relationship table 70.

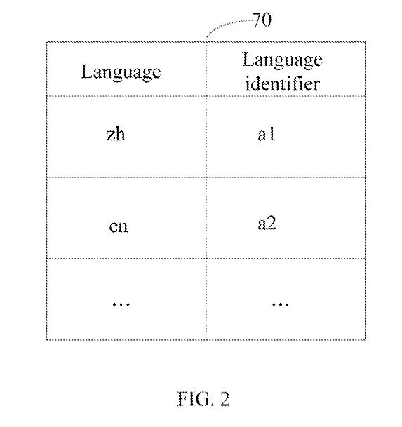

FIG. 2 illustrates a diagrammatic view of an embodiment of the relationship table 70. The relationship table 70 defines relationships between a number of languages and a number of language identifiers. In at least one embodiment, the webpage management device 100 can be a server, the electronic device 200 can be a desktop computer, a portable computer, a tablet computer, a smart phone and other terminal devices.

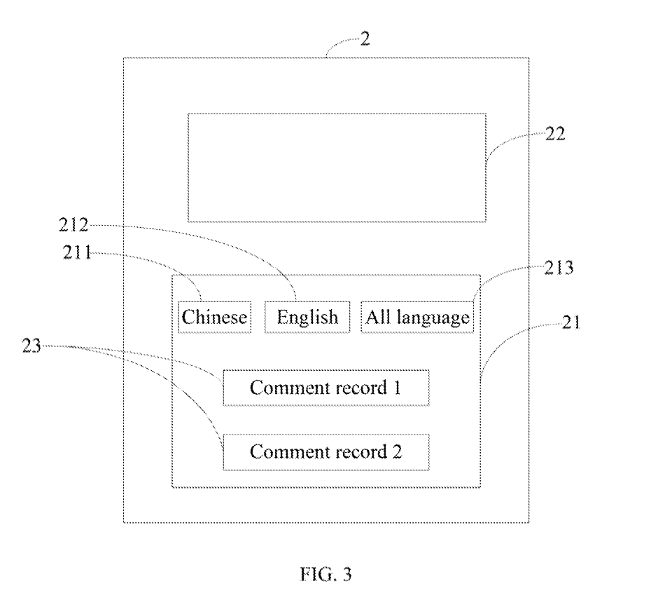

FIG. 3 illustrates a diagrammatic view of an embodiment of a webpage file 2. The webpage file 2 includes a comment display area 21 and webpage content 22. The comment display area 21 is used to display comment records 23 related to the webpage content 22 of the webpage file 2. Namely, the comment display area 21 is a display area which is used to display the comment records 23 related to the webpage content 22 of the webpage file 2. Therein, all of the comment records 23 related to the webpage content 22 of the webpage file 2 are stored in the storage device 30 of the webpage management device 100. Each comment record 23 corresponds to a language identifier. Each comment record 23 includes at least one of word, image and video information. A user is able to issue the comment record 23 via the comment display area 21.

The system 1 is used to detect the language of the browser 50 and acquire the comment records 23 related to the webpage content 22 of the webpage file 2, when the webpage file 2 is accessed by the browser 50. The system 1 is further used to select the comment records 23 whose languages match with the language of the browser 50 and display the selected comment records 23 in the comment display area 21 of the webpage file 2.

In at least one embodiment, the storage device 30 can include various types of non-transitory computer-readable storage mediums. For example, the storage device 30 can be an internal storage system, such as a flash memory, a random access memory (RAM) for temporary storage of information, and/or a read-only memory (ROM) for permanent storage of information. The storage device 30 can also be an external storage system, such as a hard disk, a storage card, or a data storage medium. The at least one processor 40 can be a central processing unit (CPU), a microprocessor, or other data processor chip that performs functions of the system 1 for classifying the comment record 23 in the webpage management device 100.

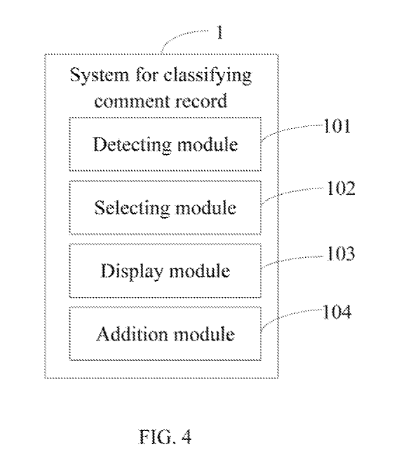

FIG. 4 illustrates in at least one embodiment, the system 1 can include a detecting module 101, a selecting module 102, a display module 103 and an addition module 104. The modules 101-104 of the system 1 can be collections of software instructions stored in the storage device 30 of the webpage management device 100 and executed by the processor 40 of the webpage management device 100. The modules 101-104 of the system 1 also can include functionality represented as hardware or integrated circuits, or as software and hardware combinations, such as a special-purpose processor or a general-purpose processor with special-purpose firmware.

The detecting module 101 is used to detect the language of the browser 50 used to access to the webpage file 2 when the webpage file 2 is accessed by the browser 50. In at least one embodiment, the detecting module 101 detects language coding of the browser 50 used to access the webpage file 2 via the “navigator.userlanguage” instruction in the JavaScript of the browser 50. The detecting module 101 then determines the language of the browser 50 according to the detected language coding of the browser 50. Therein, the language coding of the browser 50 includes language information and regional mark information of the browser 50. For example, when the detecting module 101 detects that the language coding of the browser 50 is “zh-TW” according to the “navigator.userlanguage” instruction in the JavaScript of the browser 50, therein, “zh” is the language information of the browser 50, “TW” is the regional mark information of the browser 50; the detecting module 101 determines the language information of the browser 50 is “zh” and the regional mark information is “TW”.

The selecting module 102 is used to acquire the comment records 23 related to the webpage content 22 of the webpage file 2 and the language identifier of each one comment record 23. The selecting module 102 further determines the language of each comment record 23 according to the acquired language identifier of each comment record 23 and the relationships between the number of the languages and the number of language identifiers defined in the relationship table 70. Then the selecting module 102 selects the comment records 23, whose language match with the language of the browser 50, from all of the acquired comment records 23.

In at least one embodiment, when the browser 50 is used to access the webpage file 2 and issue a comment record 23 in the comment display area 21 of the webpage file 2, a language identifier corresponding to the language of the browser 50 will be added to the issued comment record 23. When the detecting module 101 detects the language of the browser 50 used to access the webpage file 2 is Chinese, the selecting module 102 acquires the comment records 23 related to the webpage content 22 of the webpage file 2 and the language identifier of each comment record 23, determines the language of each comment record 23 according to the acquired language identifier of each one comment record 23 and the stored relationship table 70, and selects the comment records 23 whose language is Chinese from all of the acquired comment records 23.

The display module 103 is used to display the comment records 23 selected by the selecting module 102 in the comment display area 21 of the webpage file 2. In the at least one embodiment, the display module 103 is also used to sort the comment records 23 selected by the selecting module 102 in a predetermined sorting principle and display the comment records 23 in the comment display area 21 of the webpage file 2 according to the predetermined sorting principle. In at least one embodiment, the predetermined sorting principle is to sort the comment records 23 based on a hot degree of the comment records 23. Therein, the higher hot degree the comment record 23 has, the higher the comment record 23 is displayed in the comment display area 21 of the webpage file 2. The hot degree of the comment record 23 can be determined by a reply number or a vote number of the comment record 23. Therein, the more replies or votes the comment record has, the higher hot degree the comment record 23 has. In other embodiments, the predetermined sorting principle is to sort the comment records 23 based on issued time of the comment records 23. Therein, the earlier the issued time of the comment record 23 is, the higher the comment record 23 is displayed in the comment display area 21 of the webpage file 2.

In at least one embodiment, when the selecting module 102 acquires the comment records 23 related to the webpage content 22 of the webpage file 2 and determines the language of each comment record 23, the selecting module 102 further classifies the acquired comment records 23 according to the languages of the comment records 23. The display module 103 further displays the comment records 23 whose language is the same as a language selected by the user in the comment display area 21 of the webpage file 2 in response to an operation to select the language of the comment records 23. Therefore, the user can choose to display the comment records 23 with a certain language in the comment display area 21 of the webpage file 2 according to requirement and preference.

Please refer back to FIG. 3, the display module 103 displays a number of language options corresponding to the comment records 23 related to the webpage content 22 of the webpage file 2. The number of language options at least include a Chinese option 211, an English option 212, and an All language option 213. The display module 103 displays the comment records 23 corresponding to the language selected by the user via operating one language option in the comment display area 21 of the webpage file 2. For example, the display module 103 displays the comment records 23 whose language is Chinese in the comment display area 21 of the webpage file 2 in response to the operation of selecting the Chinese option 211. The display module 103 displays the comment records 23 whose language is English in the comment display area 21 of the webpage file 2 in response to the operation of selecting the English option 212. The display module 103 displays all of the comment records 23 related to the webpage content 22 of the webpage file 2 in the comment display area 21 of the webpage file 2 in response to the operation of selecting the All language option 213. Therefore, the user can choose to display the comment records 23 with different kinds of languages in the comment display area 21 of the webpage file 2 according to operations.

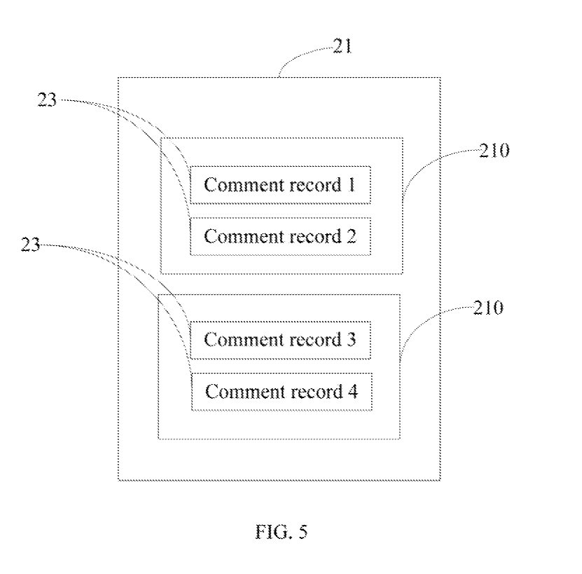

In at least one embodiment, when the display module 103 displays all of the comment records 23 related to the webpage content 22 of the webpage file 2 in the comment display area 21 in response to the operation of selecting the All language option 213, the display module 103 further displays all of the comment records 23 related to the webpage B of the webpage file 2 on different display blocks 210 in the comment display area 21 according to the language of the comment records 23. FIG. 5 illustrates a diagrammatic view of an embodiment of a comment display area 21. The comment display area 21 includes a number of display blocks 210, each display block 210 corresponds to one language. The display module 103 displays the comment records 23 with one language in the display block corresponding to the language. For example, the language of the comment records 23 related to the webpage content 22 of the webpage file 2 includes Chinese and English, when the All language option 213 is selected, the display module 103 displays the comment records 23 whose language is Chinese in the display block 210 corresponding to Chinese and the comment records 23 whose language is English in the other display block 210. It is beneficial for people from the same country or region to communicate with each other by viewing the comment records 23 in the corresponding display block 210 of the comment display area 21.

The addition module 104 is used to acquire the comment record 23 issued by the user in the comment display area 21 of webpage file 2 when the browser 50 is used to access the webpage file 2, and determine a language identifier corresponding to the language of the browser 50 according to the language detected by the detecting module 101 and the stored relationship table 70. The addition module 104 further adds the determined language identifier to the acquired comment records 23.

In at least one embodiment, when the browser 50 is used to access the webpage file 2, the addition module 104 is used to add a regional mark 230 to the comment record 23 issued by the user via the browser 50, the display module 103 further displays the comment record 23 selected by the selecting module 102 and the regional mark 230 corresponding to the comment record 23 in the comment display area 21 of the webpage file 2. In detail, as mentioned before, the detecting module 101 is able to determine the language information and regional mark information of the browser 50 via the “navigator.userlanguage” instruction in the JavaScript of the browser 50. The addition module 104 adds the regional mark 230 determined by the detecting module 101 to the comment record 23. The display module 102 displays the comment record 23 and the regional mark 230 corresponding to the comment record 23 in the comment display area 21 of the webpage file 2.

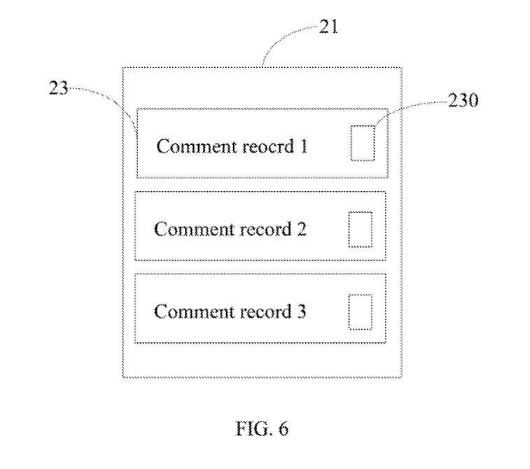

FIG. 6 illustrates a diagrammatic view of an embodiment of a comment record with a regional mark 230. For example, when the detecting module 101 detects that the regional mark information of the browser 50 is “TW”, the addition module 104 adds the regional mark “TW” to the comment record 23, the display module 103 displays the comment record 23 and the regional mark “TW” corresponding to the comment record 23 in the comment display area 21 of the webpage file 2. In other embodiments, the addition module 104 acquires a IP address of the electronic device 100 communicating with the webpage management device 100, determines location information corresponding to the acquired IP address of the electronic device 100, determines the regional mark 230 corresponding to the determined location information, and adds the determined regional mark 230 to the comment record 23. The comment record 23 with a regional mark 230 is beneficial for people within the same area or having the same cultures to communicate with each other.

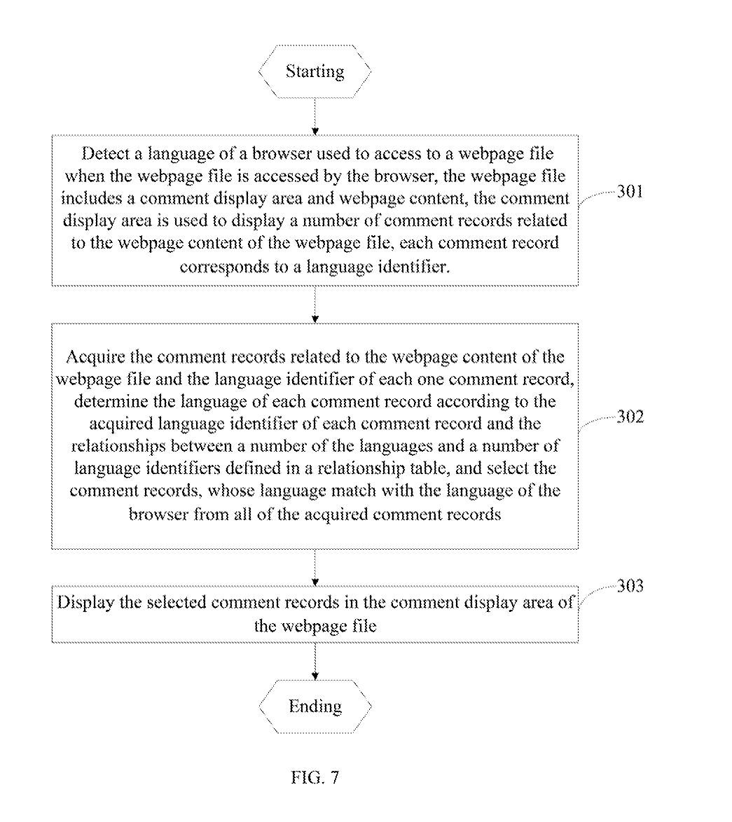

FIG. 7 illustrates a flowchart of an embodiment of a method for classifying comment records. The method is provided by way of example, as there are a variety of ways to carry out the method. The method described below can be carried out using the configurations illustrated in FIG. 1-6, for example, and various elements of these figures are referenced in explaining the example method. Each block shown in FIG. 7 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 301.

At block 301, a detecting module detects a language of a browser used to access to a webpage file when the webpage file is accessed by the browser. Therein, the webpage file includes a comment display area and webpage content, the comment display area is used to display a number of comment records related to the webpage content of the webpage file, each comment record corresponds to a language identifier. In at least one embodiment, the detecting module detects language coding of the browser used to access the webpage file via the “navigator.userlanguage” instruction in the JavaScript of the browser. The detecting module then determines the language of the browser according to the detected language coding of the browser. Therein, the language coding of the browser includes language information and regional mark information of the browser.

At block 302, a selecting module acquires the comment records related to the webpage content of the webpage file and the language identifier of each one comment record, determines the language of each comment record according to the acquired language identifier of each comment record and the relationships between a number of the languages and a number of language identifiers defined in a relationship table, and selects the comment records, whose language match with the language of the browser, from all of the acquired comment records. In at least one embodiment, when the browser is used to access the webpage file and issue a comment record in the comment display area of the webpage file, a language identifier corresponding to the language of the browser will be added to the issued comment record.

At block 303, a display module displays the comment records selected by the selecting module in the comment display area of the webpage file. In at least one present embodiment, the display module sorts the comment records selected by the selecting module in a predetermined sorting principle and displays the comment records in the comment display area of the webpage file according to the predetermined sorting principle. In at least one embodiment, the predetermined sorting principle is to sort the comment records based on a hot degree of the comment records. Therein, the higher hot degree the comment record has, the higher the comment record is displayed in the comment display area of the webpage file. The hot degree of the comment record can be determined by a reply number or a vote number of the comment record. Therein, the more replies or votes the comment record has, the higher hot degree the comment record has.

The method further includes: when the selecting module acquires the comment records related to the webpage content of the webpage file and determines the language of each comment record, the selecting module further classifies the acquired comment records according to the languages of the comment records; the display module further displays the comment records whose language is the same as a language selected by the user in the comment display area of the webpage file in response to an operation to select the language of the comment records.

In at least one embodiment, the display module displays a number of language options corresponding to the comment records related to the webpage content of the webpage file. The number of language options at least include a Chinese option, an English option and an All language option. The display module displays the comment records corresponding to the language selected by the user via operating one language option in the comment display area of the webpage file.

The method further includes: when the display module displays all of the comment records related to the webpage content of the webpage file in the comment display area in response to the operation of selecting the All language option, the display module further displays all of the comment records related to the webpage of the webpage file on different display blocks in the comment display area according to the languages of the comment records. Therein, each display block corresponds to one language, the display module displays the comment records with one language in the display block corresponding to the language.

The method further includes: when the browser is used to access the webpage file, an addition module acquires the comment record issued by the user in the comment display area of webpage file, determines a language identifier corresponding to the language of the browser according to the language of the browser detected by the detecting module and the stored relationship table, and adds the determined language identifier to the acquired comment records.

In at least one embodiment, the method further includes: the addition module further adds a regional mark to the comment record issued by the user via the browser, the display module further displays the comment record selected by the selecting module and the regional mark corresponding to the comment record in the comment display area of the webpage file.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A system for classifying comment records in a webpage file, executable on a webpage management device, the webpage file comprising a webpage content and a comment display area configured to display a plurality of comment records related to the webpage content of the webpage file, each comment record corresponding to a language identifier, the system comprising:
at least one processor; and
a plurality of modules which are collections of instructions executable by the processor, the plurality of modules comprising:
a detecting module configured to, upon execution by the at least one processor:
cause the at least one processor to detect a language of a browser when the webpage file is accessed by the browser;
a selecting module configured to, upon execution by the at least one processor:
cause the at least one processor to acquire the comment records related to the webpage content of the webpage file and the language identifier of each comment record;
determine the language of each comment record according to the acquired language identifier of each comment record and relationships between a plurality of languages and a plurality of language identifiers defined in a relationship table; and
select the comment records whose language match with the language of the browser from all of the acquired comment records; and
a display module configured to, upon execution by the at least one processor, cause the at least one processor to:
display the comment records selected by the selecting module in the comment display area of the webpage file.

2. The system according to claim 1, wherein when the selecting module acquires the comment records related to the webpage content of the webpage file and determines the language of each comment record, the selecting module further classifies the acquired comment records according to the languages of the comment records; the display module further displays the comment records whose language is the same as a language selected by the user in the comment display area of the webpage file in response to an operation to select the language of the comment records.

3. The system according to claim 2, wherein the display module is further configured to, upon execution by the at least one processor, cause the at least one processor to display a plurality of language options corresponding to the comment records, and display the comment records corresponding to the language selected by the user via operating one language option in the comment display area of the webpage file.

4. The system according to claim 3, wherein the plurality of language options comprise a Chinese option, an English option, and an All language option.

5. The system according to claim 4, wherein the display module is further configured to, upon execution by the at least one processor, cause the at least one processor to display all of the comment records related to the webpage of the webpage file on different display blocks in the comment display area according to the languages of the comment records in response to an operation of selecting the All language option, wherein, each display block corresponds to one language.

6. The system according to claim 1, wherein the plurality of modules further comprising:
an addition module configured to, upon execution by the at least one processor, cause the at least one processor to acquire the comment record issued by the user in the comment display area of webpage file, determine a language identifier according to the language of the browser detected by the detecting module and the stored relationship table, and add the determined language identifier to the acquired comment records when the webpage file is accessed by the browser.

7. The system according to claim 6, wherein the addition module is further configured to add a regional mark to the comment record issued by the user via the browser; the display module is further configured to display the comment record selected by the selecting module and the regional mark corresponding to the comment record in the comment display area of the webpage file.

8. A method for classifying comment record in a webpage file, the webpage file comprising a webpage content and a comment display area configured to display a plurality of comment records related to the webpage content of the webpage file, each comment record corresponding to a language identifier, the method comprising:
detecting a language of a browser when the webpage file is accessed by the browser;
acquiring the comment records related to the webpage content of the webpage file and the language identifier of each comment record, determining the language of each comment record according to the acquired language identifier of each comment record and relationships between a plurality of languages and a plurality of language identifiers defined in a relationship table, and selecting the comment records whose language match with the language of the browser from all of the acquired comment records; and
displaying the selected comment records in the comment display area of the webpage file.

9. The method according to claim 8, wherein when acquiring the comment records related to the webpage content of the webpage file and determining the language of each comment record, the method further comprising:
classifying the acquired comment records according to the languages of the comment records; and
displaying the comment records whose language is the same as a language selected by the user in the comment display area of the webpage file in response to an operation to select the language of the comment records.

10. The method according to claim 9, wherein the method further comprising:
displaying a plurality of language options corresponding to the comment records, and displaying the comment records corresponding to the language selected by the user via operating one language option in the comment display area of the webpage file.

11. The method according to claim 10, wherein the plurality of language options comprise a Chinese option, an English option, and an All language option.

12. The method according to claim 11, wherein the method further comprising:
displaying all of the comment records related to the webpage of the webpage file on different display blocks in the comment display area according to the languages of the comment records in response to an operation of selecting the All language option, wherein, each display block corresponds to one language.

13. The method according to claim 8, wherein the method further comprising:
acquiring the comment record issued by the user in the comment display area of webpage file, determining a language identifier according to the detected language of the browser and the stored relationship table, and adding the determined language identifier to the acquired comment records when the browser is used to access the webpage file.

14. The method as according to claim 13, wherein the method further comprising:
adding a regional mark to the comment record issued by the user via the browser; and
displaying the selected comment record and the regional mark corresponding to the comment record in the comment display area of the webpage file.

15. A webpage management device comprising:
a communicating unit configured to make the webpage management device communicate with at least one electronic device which comprises a browser;
a storage device configured to store a plurality of webpage files and a relationship table, each webpage files comprising a webpage content and a comment display area configured to display comment records related to the webpage content of the webpage file, each comment record corresponding to a language identifier; the relationship table defining relationships between a plurality of languages and a plurality of language identifiers;
at least one processor configured to execute the plurality of modules, the plurality of modules comprising:
a detecting module configured to, upon execution by the at least one processor, cause the at least one processor to detect the language of the browser used to access to the webpage file when the webpage file is accessed by the browser;
a selecting module configured to, upon execution by the at least one processor, cause the at least one processor to acquire comment records related to webpage content of the webpage file and the language identifier of each one comment record, determines the language of each comment record according to the acquired language identifier of each comment record and the relationships between a plurality of languages and a plurality of language identifiers defined in the relationship table, and selects the comment records, whose language match with the language of the browser, from all of the acquired comment records; and
a display module configured to, upon execution by the at least one processor, cause the at least one processor to display the comment records selected by the selecting module in the comment display area of the webpage file.

16. The webpage management device according to claim 15, wherein when the selecting module acquires the comment records related to the webpage content of the webpage file and determines the language of each comment record, the selecting module further classifies the acquired comment records according to the languages of the comment records; the display module further displays the comment records whose language is the same as a language selected by the user in the comment display area of the webpage file in response to an operation to select the language of the comment records.

17. The webpage management device according to claim 16, wherein the display module is further configured to, upon execution by the at least one processor, cause the at least one processor to display a plurality of language options corresponding to the comment records, and display the comment records corresponding to the language selected by the user via operating one language option in the comment display area of the webpage file.

18. The webpage management device according to claim 17, wherein the plurality of language options comprise a Chinese option, an English option, and an All language option.

19. The webpage management device according to claim 17, wherein the display module is further configured to, upon execution by the at least one processor, cause the at least one processor to display all of the comment records related to the webpage of the webpage file on different display blocks in the comment display area according to the languages of the comment records in response to an operation of selecting the All language option, wherein, each display block corresponds to one language.

20. The webpage management device according to claim 15, wherein the plurality of modules further comprising:
an addition module configured to, upon execution by the at least one processor, cause the at least one processor to acquire the comment record issued by the user in the comment display area of webpage file, determine a language identifier according to the language of the browser detected by the detecting module and the stored relationship table, and add the determined language identifier to the acquired comment records when the browser is used to access the webpage file.
